(19) United States
(12) Patent Application Publication
(10) Pub. No.: US 2010/0174025 A1
(43) Pub. Date: Jul. 8, 2010

(54) N-BA-ALKENE COPOLYMERS AS GRAFT BASE FOR ABS POLYMERS

(75) Inventors: Michael Ishaque, Mannheim (DE); Rajan Venkatesh, Mannheim (DE); Maarten Staal, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/160,945

(22) PCT Filed: Jan. 18, 2007
(86) PCT No.: PCT/EP2007/050471

§ 371 Date: Jul. 15, 2008

(30) Foreign Application Priority Data
Jan. 19, 2006 (EP) 06100615.1

(51) Int. Cl. C08L 51/00; C08F 220/10

(52) U.S. Cl. 524/504; 525/80; 526/328.5

(57) ABSTRACT

A thermoplastic molding composition is proposed, comprising a graft copolymer A and a thermoplastic copolymer B in the following proportions by weight:
A: from 10 to 80% by weight of the graft copolymer A composed of
   a1: from 30 to 90% by weight, based on the graft copolymer A, of a graft base a1 obtainable via the reaction of
      a11: from 50 to 98.99% by weight, based on the graft base a1, of a C₁-C₁₀-alkyl ester of acrylic acid,
      a12: from 1 to 49.99% by weight, based on the graft base a1, of a copolymerizable linear, branched or cyclic olefin having from 2 to 12 carbon atoms, and
      a13: from 0.01 to 10% by weight, based on the graft base a1, of a co-polymerizable polyfunctional, crosslinking compound,
      where the entirety a11+a12+a13 gives 100% by weight; and
   a2: from 10 to 70% by weight, based on the graft copolymer A, of a graft a2;
   where the entirety composed of graft base a1 and graft a2 gives 100% by weight; and
B: from 20 to 90% by weight of a thermoplastic copolymer B,
where the entirety composed of graft copolymer A and of thermoplastic copolymer B gives 100%.

The present invention relates to molding compositions with very good weathering resistance, improved chemical resistance and improved low-temperature toughness. The inventive molding compositions are based on rubber modifiers composed of low-cost, very readily available monomers, and exhibit a balanced ratio of toughness and stiffness together with good flowability. The inventive molding compositions comprise
A from 10 to 80% by weight of the graft copolymer A composed of
   a1 from 30 to 90% by weight, based on the graft copolymer A, of the graft base a1 based on a crosslinked copolymer composed of alkyl acrylate and of an olefin and
   a2 from 10 to 70% by weight, based on the graft copolymer A, of the graft a2 and
B from 20 to 90% by weight of a thermoplastic copolymer.

The present invention moreover relates to the use of the molding compositions described above for the production of moldings, of semifinished products, of fibers, of foils, or of foams, and also to moldings, semifinished products, fibers, foils or foams produced from the inventive thermoplastic molding compositions.

Rubber-modified polymers are used to produce a very wide variety of consumer articles, because they have very good mechanical properties. In particular, rubbers based on crosslinked polyacrylates are used for modification, since these feature high weathering resistance due to their saturated character.

Rubbers with very good weathering resistance are known and are used as impact modifiers in a polymeric matrix, in particular in outdoor applications. For example, WO 05/12395 discloses an acrylate-rubber-modified molding composition with good impact and tensile strengths. U.S. Pat. No. 5,773,520 discloses impact-modified thermoplastic mixtures with improved mechanical properties at low temperatures, but there is no description of styrene (co)polymers.

DE 11 64 080 presents rubber-modified, impact-resistance thermoplastics of this type with good weathering resistance composed of crosslinked polyacrylates and of a brittle component, e.g. polystyrene or polymethyl methacrylate.

DE 195 08 312 and EP 0 675 164 describe weathering-resistant thermoplastic molding compositions in which impact-modifiers used comprise graft copolymers with a core composed of crosslinked polyacrylate which has been copolymerized with other monomers, such as isoprene, butadiene, acrylnitrile or styrene, and with a shell composed of a brittle copolymer such as poly(styrene-acrylnitrile).

DE 199 59 420 reveals the use of elastomers with a glass transition temperature T₅<10° C. based on acrylates, on ethylene, on propylene, on dienes or on siloxanes as graft base for impact-modifiers in molding compositions which comprise polycarbonate and styrene copolymers.

Since thermoplastics modified with crosslinked polyacrylates are highly versatile and have good mechanical properties and high weathering resistance, a low-cost alternative for the preparation of these thermoplastic molding compositions is desirable. The molding compositions here should have improved low-temperature properties, and improved intrinsic color and chemical resistance. These thermoplastic molding compositions are intended more-over to exhibit a balanced ratio of toughness and stiffness together with good flowability and weathering resistance.

It was an object of the present invention to provide a low-cost rubber which is accessible via a simple preparation process and which can be used for the impact-modification of styrene(co)polymers and which features improved low-temperature properties, and improved intrinsic color and chemical resistance, with no resultant adverse effect on weathering resistance and toughness-stiffness ratio.

Accordingly, thermoplastic molding compositions have been found which comprise a graft copolymer A and a thermoplastic copolymer B in the following proportions by weight:
A: from 10 to 80% by weight of the graft copolymer A composed of
a1: from 30 to 90% by weight, based on the graft copolymer A, of a graft base a1 obtainable via the reaction of
   a11: from 50 to 98.99% by weight, based on the graft base a1 , of a C₁-C₁₀ alkyl ester of acrylic acid,
   a12: from 1 to 49.99% by weight, based on the graft base a1, of a copolymerizable linear, branched or cyclic olefin having from 2 to 12 carbon atoms, and
   a13: from 0.01 to 10% by weight, based on the graft base at of a copolymerizable polyfunctional, crosslinking compound,
   where the entirety a11+a12+a13 gives 100% by weight; and
a2: from 10 to 70% by weight, based on the graft copolymer A, of a graft a2;
where the entirety composed of graft base a1 and graft a2 gives 100% by weight; and
B: from 20 to 90% by weight of a thermoplastic copolymer B,
where the entirety composed of graft copolymer A and of thermoplastic copolymer B gives 100%.

One embodiment provides the thermoplastic molding compositions described above, where copolymerizable, linear, branched or cyclic α-olefins having from 2 to 12 carbon atoms are used as component a12.

Further thermoplastic molding compositions have also been found which comprise a graft copolymer A and a thermoplastic copolymer B in the following proportions by weight:
A: from 10 to 80% by weight of the graft copolymer A composed of
a1: from 30 to 90% by weight, based on the graft copolymer A, of a graft base a1 obtainable via the reaction of
   a11: from 50 to 98.99% by weight, based on the graft base a1, of a C₁-C₁₀-alkyl ester of acrylic acid,
   a12: from 1 to 49.99% by weight, based on the graft base a1, of a copolymerizable linear, branched or cyclic olefin having 2, 3, 4 or from 5 to 12 carbon atoms, and
   a13: from 0.01 to 10% by weight, based on the graft base a1, of a copolymerizable polyfunctional, crosslinking compound,
   where the entirety a11+a12+a13 gives 100% by weight; and
a2: from 10 to 70% by weight, based on the graft copolymer A, of a graft a2;
   where the entirety composed of graft base a1 and graft a2 gives 100% by weight; and
B: from 20 to 90% by weight of a thermoplastic copolymer B,
where the entirety composed of graft copolymer A and of thermoplastic copolymer B gives 100%.

A further embodiment includes the molding composition described above, in which a co-polymerizable linear, branched or cyclic α-olefin having 2, 3, 4 or from 5 to 12 carbon atoms is used as component a12.

The present invention further provides novel emulsion rubbers based on copolymers composed of acrylates and of alkenes for use as impact-modifiers.

The use of the molding composition as described above has moreover been found for the production of moldings, of semifinished products, of fibers, of foils or of foams, as also have the moldings, semifinished products, fibers, foils or foams produced from the inventive thermoplastic molding compositions.

The inventive molding compositions can comprise not only the graft copolymer A and the thermoplastic copolymer B but also one or more further polymers C. It is also possible to add fibrous or particulate fillers D to the molding composition. Optionally, conventional additives and processing aids E can also be added. The inventive molding compositions can comprise the following proportions by weight of components C, D and/or E (where the % by weight values are always based on the total weight of components A and B):
from 0 to 90% by weight of one or more further thermoplastic polymers C
from 0 to 50% by weight of fibrous or particulate fillers or a mixture of these D
from 0 to 30% by weight of conventional additives and processing aids E.

The amount of the graft copolymer A comprised in the molding composition is from 10 to 80% by weight, preferably from 20 to 70% by weight, particularly preferably from 25 to 60% by weight. (The % by weight values are always based on the total weight of components A and B.)

The amount of the thermoplastic copolymer B comprised in the molding composition is from 20 to 90% by weight, preferably from 30 to 80% by weight, particularly preferably from 40 to 75% by weight. (The % by weight values are again always based on the total weight of components A and B.)

The inventive particles and uses are described below:

### Component A (Graft Copolymer)

The graft copolymer A is composed of from 30 to 90% by weight, preferably from 40 to 80% by weight, particularly preferably from 45 to 70% by weight, of the graft base a1 and of from 10 to 70% by weight, preferably from 20 to 60% by weight, particularly preferably from 30 to 55% by weight, of the graft a2 (where the % by weight values are always based on the weight of component A).

The graft base a1 is obtainable via reaction of
from 50 to 98.99% by weight, preferably from 70 to 98.75% by weight, particularly preferably from 85 to 98.7% by weight, of component a11, and
from 1 to 49.99% by weight, preferably from 2 to 45% by weight, particularly preferably from 5 to 40% by weight, of component a12, and
from 0.01 to 10% by weight of component a13.

The % by weight values are based on the graft base a1.

The graft a2 is obtainable via reaction of
from 60 to 95% by weight, preferably from 65 to 80% by weight, particularly preferably from 70 to 75% by weight, of component a21, and
from 5 to 40% by weight, preferably from 20 to 35% by weight, particularly preferably from 25 to 30% by weight, of component a22 and
from 0 to 35% by weight, preferably from 0 to 15% by weight, particularly preferably from 0 to 5% by weight, of component a23
   in the presence of the graft base a1. The % by weight values are always based on the weight of component a2.

According to the invention, the component a11 used can comprise monomers such as one or more C₁-C₁₀-alkyl esters of acrylic acid. Preferred components a11 are methyl acrylate, n-butyl acrylate, tert-butyl acrylate, hexyl acrylate, 2-ethylhexyl acrylate or octyl acrylate or a mixture of these, in particular n-butyl acrylate or 2-ethylhexyl acrylate or a mixture of these.

n-Butyl acrylate and ethylhexyl acrylate are particularly preferred as component a11.

The component a12 used can comprise monomers such as any of the linear, branched or cyclic alkenes having 2, 3, 4 or from 5 to 12 carbon atoms which are capable of free-radical copolymerization and which have no further elements alongside carbon and hydrogen. Among these are, by way of example, the acrylic alkenes 2-butene, 2-methylpropene, 2-methyl-1-butene, 3-methyl-1-butene, 3,3-dimethyl-2-isopropyl-1-butene, 2-methyl-2-butene, 3-methyl-2-butene, 1-pentene, 2-methyl-1-pentene, 3-methyl-1-pentene, 4-methyl-1-pentene, 2-pentene, 2-methyl-2-pentene, 3-methyl-2-pentene, 4-methyl-2-pentene, 2-ethyl-1-pentene, 3-ethyl-1-pentene, 4-ethyl-1-pentene, 2-ethyl-2-pentene, 3-ethyl-2-pentene, 4-ethyl-2-pentene, 2,4,4-trimethyl-1-pentene, 2,4,4-trimethyl-2-pentene, 3-ethyl-2-methyl-1-pentene, 3,4,4-trimethyl-2-pentene, 2-methyl-3-ethyl-2-pentene, 1-hexene, 2-methyl-1-hexene, 3-methyl-1-hexene, 4-methyl-1-hexene, 5-methyl-1-hexene, 2-hexene, 2-methyl-2-hexene, 3-methyl-2-hexene, 4-methyl-2-hexene, 5-methyl-2-hexene, 3-hexene, 2-methyl-3-hexene, 3-methyl-3-hexene, 4-methyl-3-hexene, 5-methyl-3-hexene, 2,2-dimethyl-3-hexene, 2,3-dimethyl-2-hexene, 2,5-dimethyl-3-hexene, 2,5-dimethyl-2-hexene, 3,4-dimethyl-1-hexene, 3,4-dimethyl-3-hexene, 5,5-dimethyl-2-hexene, 2,4-dimethyl-1-hexene, 1-heptene, 2-methyl-1-heptene, 3-methyl-1-heptene, 4-methyl-1-heptene, 5-methyl-1-heptene, 6-methyl-1-heptene, 2-heptene, 2-methyl-2-heptene, 3-methyl-2-heptene, 4-methyl-2-heptene, 5-methyl-2-heptene, 6-methyl-2-heptene, 3-heptene, 2-methyl-3-heptene, 3-methyl-3-heptene, 4-methyl-3-heptene, 5-methyl-3-heptene, 6-methyl-3-heptene, 6,6-dimethyl-1 -heptene, 3,3-dimethyl-1-heptene, 3,6-dimethyl-1-heptene, 2,6-dimethyl-2-heptene, 2,3-dimethyl-2-heptene, 3,5-dimethyl-2-heptene, 4,5-dimethyl-2-heptene, 4,6-dimethyl-2 heptene, 4-ethyl-3-heptene, 2,6-dimethyl-3-heptene, 4,6-dimethyl-3-heptene, 2,5-dimethyl-4-heptene, 1-octene, 2-methyl-1-octene, 3-methyl-1-octene, 4-methyl-1-octene, 5-methyl-1-octene, 6-methyl-1-octene, 7-methyl-1-octene, 2-octene, 2-methyl-2-octene, 3-methyl-2-octene, 4-methyl-2-octene, 5-methyl-2-octene, 6-methyl-2-octene, 7-methyl-2-octene, 3-octene, 2-methyl-3-octene, 3-methyl-3-octene, 4-methyl-3-octene, 5-methyl-3-octene, 6-methyl-3-octene, 7-methyl-3-octene, 4-octene, 2-methyl-4-octene, 3-methyl-4-octene, 4-methyl-4-octene, 5-methyl-4-octene, 6-methyl-4-octene, 7-methyl-4-octene, 7,7-dimethyl-1-octene, 3,3-dimethyl-1-octene, 4,7-dimethyl-1-octene, 2,7-dimethyl-2-octene, 2,3-dimethyl-2-octene, 3,6-dimethyl-2-octene, 4,5-dimethyl-2-octene, 4,6-dimethyl-2-octene, 4,7-dimethyl-2-octene, 4-ethyl-3-octene, 2,7-dimethyl-3-octene, 4,7-dimethyl-3-octene, 2,5-dimethyl-4-octene, 1-nonene, 2-methyl-1-nonene, 3-methyl-1-nonene, 4-methyl-1-nonene, 5-methyl-1-nonene, 6-methyl-1-nonene, 7-methyl-1-nonene, 8-methyl-1-nonene, 2-nonene, 2-methyl-2-nonene, 3-methyl-2-nonene, 4-methyl-2-nonene, 5-methyl-2-nonene, 6-methyl-2-nonene, 7-methyl-2-nonene, 8-methyl-2-nonene, 3-nonene, 2-methyl-3-nonene, 3-methyl-3-nonene, 4-methyl-3-nonene, 5-methyl-3-nonene, 6-methyl-3-nonene, 7-methyl-3-nonene, 8-methyl-3-nonene, 4-nonene, 2-methyl-4-nonene, 3-methyl-4-nonene, 4-methyl-4-nonene, 5-methyl-4-nonene, 6-methyl-4-nonene, 7-methyl-4-nonene, 8-methyl-4-nonene, 4,8-dimethyl-1-nonene, 4,8-dimethyl-4-nonene, 2,8-dimethyl-4-nonene, 1-decene, 2-methyl-1-decene, 3-methyl-1-decene, 4-methyl-1-decene, 5-methyl-1-decene, 6-methyl-1-decene, 7-methyl-1-decene, 8-methyl-1-decene, 9-methyl-1-decene, 2-decene, 2-methyl-2-decene, 3-methyl-2-decene, 4-methyl-2-decene, 5-methyl-2-decene, 6-methyl-2-decene, 7-methyl-2-decene, 8-methyl-2-decene, 9-methyl-2-decene, 3-decene, 2-methyl-3-decene, 3-methyl-3-decene, 4-methyl-3-decene, 5-methyl-3-decene, 6-methyl-3-decene, 7-methyl-3-decene, 8-methyl-3-decene, 9-methyl-3-decene, 4-decene, 2-methyl-4-decene, 3-methyl-4-decene, 4-methyl-4-decene, 5-methyl-4-decene, 6-methyl-4-decene, 7-methyl-4-decene, 8-methyl-4-decene, 9-methyl-4-decene, 5-decene, 2-methyl-5-decene, 3-methyl-5-decene, 4-methyl-5-decene, 5-methyl-5-decene, 6-methyl-5-decene, 7-methyl-5-decene, 8-methyl-5-decene, 9-methyl-5-decene, 2,4-dimethyl-1-decene, 2,4-dimethyl-2-decene, 4,8-dimethyl-1-decene, 1-undecene, 2-methyl-1-undecene, 3-methyl-1-undecene, 4-methyl-1-undecene, 5-methyl-1-undecene, 6-methyl-1-undecene, 7-methyl-1-undecene, 8-methyl-1-undecene, 9-methyl-1-undecene, 10-methyl-1-undecene, 2-undecene, 2-methyl-2-undecene, 3-methyl-2-undecene, 4-methyl-2-undecene, 5-methyl-2-undecene, 6-methyl-2-undecene, 7-methyl-2-undecene, 8-methyl-2-undecene, 9-methyl-2-undecene, 10-methyl-2-undecene, 3-undecene, 2-methyl-3-undecene, 3-methyl-3-undecene, 4-methyl-3-undecene, 5-methyl-3-undecene, 6-methyl-3-undecene, 7-methyl-3-undecene, 8-methyl-3-undecene, 9-methyl-3-undecene, 10-methyl-3-undecene, 4-undecene, 2-methyl-4-undecene, 3-methyl-4-undecene, 4-methyl-4-undecene, 5-methyl-4-undecene, 6-methyl-4-undecene, 7-methyl-4-undecene, 8-methyl-4-undecene, 9-methyl-4-undecene, 10-methyl-4-undecene, 5-undecene, 2-methyl-5-undecene, 3-methyl-5-undecene, 4-methyl-5-undecene, 5-methyl-5-undecene, 6-methyl-5-undecene, 7-methyl-5-undecene, 8-methyl-5-undecene, 9-methyl-5-undecene, 10-methyl-5-undecene, 1-dodecene, 2-dodecene, 3-dodecene, 4-dodecene, 5-dodecene or 6-dodecene, and also the cyclic alkenes cyclopentene, 2-methyl-1-cyclopentene, 3-methyl-1-cyclopentene, 4-methyl-1-cyclopentene, 3-butyl-1-cyclopentene, vinylcyclopentane, cyclohexene, 2-methyl-1-cyclohexene, 3-methyl-1-cyclohexene, 4-methyl-1-cyclohexene, 1,4-dimethyl-1-cyclohexene, 3,3,5-trimethyl-1-cyclohexene, 4-cyclopentyl-1-cyclohexene, vinylcyclohexane, cycloheptene, 1,2-dimethyl-1-cycloheptene, cyclooctene, 2-methyl-1-cyclooctene, 3-methyl-1-cyclooctene, 4-methyl-1-cyclooctene, 5-methyl-1-cyclooctene, cyclononene, cyclodecene, cycloundecene, cyclododecene, bicyclo[2.2.1]-2-heptene, 5-ethylbicyclo[2.2.1]-2-heptene, 2-methylbicyclo [2.2.2]-2-octene, bicyclo[3.3.1]-2-nonene or bicyclo[3.2.2]-6-nonene.

Preference is given to use of u-olefins having 2, 3, 4 and from 5 to 12 carbon atoms, for example ethene, propene, 1-butene, 1-pentene, 1-hexene, 1-heptene, 1-octene, 1-nonene, 1-decene, 1-undecene, 1-dodecene, 2,4,4-trimethyl-1-pentene, 2,4-dimethyl-1-hexene, 6,6-dimethyl-1-heptene or 2-methyl-1-octene. It is, of course, also possible to use a mixture of the abovementioned components a12.

It is preferable to use ethylene, propylene, n-butene, isobutene, 1-pentene, 1-hexene, 1-heptene and 1-octene as component a12.

It is particularly preferable to use ethylene, propylene, 1-butene and isobutene as component a12.

The component a13 used can in principle comprise any of the crosslinking monomers. Examples of polyfunctional, crosslinking monomers are di- and trivinylbenzene, diethyl phthalate, triallyl cyanurate, triallyl isocyanurate, dihydrodicyclopentadienyl acrylate, triallyl phosphate, allyl esters of saturated and unsaturated carboxylic acids, e.g. mono- and diallyl maleate, mono- and diallyl fumarate, mono- and diallyl itaconate, diallyl phthalate, allyl acrylate and allyl methacrylate and dienes such as butadiene and isoprene.

The component a21 used comprises monomers such as styrene and styrene derivatives, e.g. styrenes substituted with alkyl groups comprising from 1 to 8 carbon atoms, for example α-methylstyrene and vinyltoluenes such as p-methylstyrene or a mixture of these monomers, styrene being preferred.

The component a22 used comprises monomers such as unsaturated nitriles, e.g. acrylonitrite and methacrylonitrile, preferably acrylonitrile.

In principle, any of the unsaturated monomers other than those described under components a21 and a22 can be used as component a23. Suitable compounds by way of example are the monoethylenically unsaturated monomers mentioned in a11; vinylaromatic monomers such as styrene derivatives, methacrylonitrile, glycidyl esters, glycidyl acrylate and glycidyl methacrylate; N-substituted maleimides such as N-methyl-, N-vinyl- and N-cyclohexylmaleimide; acrylic acid, methacrylic acid; and moreover dicarboxylic acids such as maleic acid; nitrogen-functional monomers such as dimethylaminoethyl acrylate, di-ethylaminoethyl acrylate, vinylimidazole, vinylpyrrolidone, vinylcaprolactam, vinylcarbazole, vinylaniline; aromatic and araliphatic esters of acrylic acid and methacrylic acid such as vinyl acrylate, vinyl methacrylate, benzyl acrylate, benzyl methacrylate, 2-phenylethyl acrylate, 2-phenylethyl methacrylate, 2-phenoxyethyl acrylate, 2-phenoxyethyl methacrylate, 2-vinylethyl acrylate, 2-vinylmethyl acrylate, 2-vinoxyethyl acrylate and 2-vinoxyethyl methacrylate; unsaturated ethers such as vinyl methyl ether, and also mixtures composed of 2 or more of these monomers. Methyl acrylate and glycidyl acrylate or glycidyl methacrylate are preferred.

However, alongside these monoethylenically unsaturated monomers other suitable monomers are crosslinking and/or grafting monomers which comprise 2 or more copolymerizable double bonds. By way of example, the compounds described as component a13 are suitable, as also are other crosslinking agents or grafting compounds which are known to the person skilled in the art or are described in the literature, examples being dienes such as butadiene or isoprene and (meth)acrylic esters of polyols, an example being polyethylene glycol dimethacrylate.

The amounts that can be used as component a23 of these crosslinking agents or grafting compounds described in the previous paragraph are generally from 0 to 10% by weight, preferably from 0 to 5% by weight, always based on the total weight of component a22. In one particularly preferred embodiment of the invention, however, component a23 comprises no compounds that act as crosslinking agent and/or as grafting agent.

Suitable preparation processes for the graft copolymers A are emulsion, solution, bulk or suspension polymerization. The graft copolymers A are preferably prepared via aqueous free-radical emulsion polymerization.

Suitable polymerization processes are described in WO 02/10222, DE-A 28 26 925, 31 49 358 and DE-C 12 60 135.

It is preferable to prepare the graft base by the process described in the unpublished application numbered 102005055537.3, of which the Office is aware. The free-radical-initiated aqueous emulsion polymerization can be carried out by using at least a portion of the monomers a11 to a13 as initial charge in the aqueous reaction medium and adding the remaining residual amount, if appropriate, to the aqueous reaction medium after initiation of the free-radical polymerization reaction. However, it is also possible to use at least a portion of the free-radical polymerization initiator as initial charge in the aqueous reaction medium, to heat the resultant aqueous reaction medium to polymerization temperature, and at this temperature to add the monomers a11 to a13 to the aqueous reaction medium. It is particularly advantageous to add the monomers a11 to a13 to the aqueous reaction medium in the form of a mixture. It is very particularly preferable to add the monomers a11 to a13 in the form of an aqueous monomer emulsion.

The reaction is initiated via water-soluble or oil-soluble free-radical polymerization initiators such as inorganic or organic peroxides, e.g. peroxodisulfate or benzoyl peroxide or else azo compounds such as 2,2′-azobis(isobutylnitrile) or with the aid of redox initiators. Redox Initiators are also suitable for polymerization below 20 degrees.

The amount of the free-radical initiator used, based on the total amount of monomer, is generally from 0.01 to 5% by weight, preferably from 0.1 to 3% by weight and particularly preferably from 0.2 to 1.5% by weight.

According to the invention, the total amount of the free-radical initiator can be used as initial charge in the aqueous reaction medium. However, it is also possible, if appropriate, to use merely a portion of the free-radical initiator as initial charge in the aqueous reaction medium and then to add the total amount or, if appropriate, the remaining residual amount as required by consumption continuously or batchwise during the inventive free-radical emulsion polymerization.

For the purposes of the process described, dispersing agents are used which keep the monomer droplets and also the polymer particles formed in dispersion in the aqueous medium and thus ensure that the resultant aqueous polymer dispersion is stable. Dispersing agents that can be used comprise not only the protective colloids usually used for conduct of free-radical aqueous emulsion polymerizations but also emulsifiers.

Examples of suitable protective colloids are polyvinyl alcohols, polyalkylene glycols, alkali metal salts of polyacrylic acids and polymethacrylic acids, gelatin derivatives or copolymers comprising acrylic acid, methacrylic acid, maleic anhydride, 2-acrylamido-2-methylpropanesulfonic acid and/or 4-styrenesulfonic acid, and the alkali metal salts of these copolymers, and also homo- and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amine-group-bearing acrylates, methacrylates, acrylamides and/or methacrylamides. Houben-Weyl, Methoden der organischen Chemie, [Methods of organic chemistry], volume XIV/1, Makromolekulare Stoffe, [Macromolecular substances], Georg-Thieme-Verlag, Stuttgart, 1961, pages 411-420 gives a detailed description of other suitable protective colloids.

It is, of course, also possible to use a mixture composed of protective colloids and/or of emulsifiers. The dispersing agents used often comprise exclusively emulsifiers whose macromolecular weights, unlike those of the protective colloids, are usually below 1000. They can be either anionic, cationic, or non-ionic. If mixtures of surfactants are used, the individual components must, of course, be compatible with one another, and a few preliminary experiments can be used to check this in case of doubt. Anionic emulsifiers are generally compatible with one another and with non-ionic emulsifiers. The same applies to cationic emulsifiers, while anionic and cationic emulsifiers are mostly not compatible with one another. Houben-Weyl, Methoden der organischen Chemie, [Methods of organic chemistry], volume XIV/1, Makromolekulare Stoffe, [Macromolecular substances], Georg-Thieme-Verlag, Stuttgart, 1961, pages 192-208 gives an overview of suitable emulsifiers.

According to the invention, however, emulsifiers are in particular used as dispersing agents.

Suitable emulsifiers that can be used are anionic, cationic or non-ionic surfactants.

Examples of familiar non-ionic emulsifiers are ethoxylated mono-, di- and trialkylphenols and also ethoxylated fatty alcohols.

Examples of usual anionic emulsifiers are the alkali metal and ammonium salts of alkyl sulfates (alkyl radical: C₈-C₁₂), of sulfuric half-esters of ethoxylated alkanols (alkyl radical: C₁₂-C₁₈) and of ethoxylated alkylphenols (alkyl radicals: C₄-C₁₂) and of alkylsulfonic acids (alkyl radical: C₁₂-C₁₈).

Suitable cationic emulsifiers are generally C₆-C₁₈-alkyl-bearing or alkylaryl-bearing or heterocyclic-radical-bearing primary, secondary, tertiary or quaternary ammonium salts, pyridinium salts, imidazolinium salts, ozazolinium salts, morpholinium salts, tropylium salts, sulfonium salts and phosphonium salts. By way of example, mention may be made of dodecylammonium acetate or the corresponding sulfate, disullates or acetates of the various 2-(N,N,N-trimethylammonium)ethyl paraffinates, N-cetylpyridinium sulfate and N-lauryl-pyridinium sulfate.

The emulsifiers and protective colloids can also be used in the form of mixtures.

The total amount used of the emulsifiers preferably used as dispersing agents is advantageously from 0.005 to 10% by weight, preferably from 0.01 to 5% by weight, in particular from 0.1 to 3% by weight, always based on the total monomer concentration.

The total amount used of the protective colloids used as dispersing agents, instead of the emulsifiers or in addition thereto is often from 0.1 to 10% by weight and frequently from 0.2 to 7% by weight, always based on the total concentration of monomers.

However, the dispersing agents used preferably comprise anionic and/or non-ionic emulsifiers and particularly preferably anionic emulsifiers.

Further polymerization auxiliaries that can be used in the polymerization are the conventional buffer substances which can establish pH values which are preferably from 6 to 9, examples being sodium bicarbonate and sodium pyrophosphate, and also from 0 to 3% by weight of a molecular weight regulator, such as mercaptans, terpinols or dimeric α-methylstyrene.

The reaction can be carried out in the range from 0 to 170° C. The temperatures used are generally from 40 to 120° C., often from 50 to 110° C. and frequently from 60 to 100° C.

Optionally, the free-radical-initiated aqueous emulsion polymerization can also be carried out in the presence of a polymer, for example in the presence of from 0.01 to 3% by weight, often from 0.03 to 2% by weight and frequently from 0.04 to 1.5% by weight, of a polymer seed, in each case based on the total amount of monomer.

A polymer seed is used particularly when the particle size of the polymer particles to be prepared by means of free-radical aqueous emulsion polymerization is to be set in a controlled fashion, as described in U.S. Pat. No. 2,520,959 and U.S. Pat. No. 3,397,165.

The copolymers prepared as described above are a suitable graft base for the preparation of graft copolymers which can be used as impact-modifiers in thermoplastics, in particular the emulsion rubbers prepared by means of emulsion polymerization based on acrylates and on alkenes.

The graft a2 is preferably applied by grafting via emulsion polymerization processes. According to one embodiment of the invention, the graft is polymerized from a monomer mixture, comprising components a21, a22 and, if appropriate, a23 in the presence of the latex obtained by the process described above (composed of the graft base a1). The monomers a21, a22 and, if appropriate, a23 can be added here Individually or in a mixture with one another. By way of example, styrene can first be applied alone in the grafting process and can be followed by a mixture composed of styrene and acrylnitrile. It is advantageous that this graft copolymerization is again carried out in aqueous emulsion under the usual conditions described above. The system in which the graft copolymerization is carried out can advantageously be the same as that in which the emulsion polymerization to prepare the graft base a1 is carried out, and it is possible to add further emulsifier and initiator and also auxiliary here if necessary. According to one embodiment of the invention, the monomer mixture to be applied by grafting can be added to the reaction mixture all at once, in portions in a number of stages—for example for construction of two or more grafts—or proferably continuously during the polymerization. The graft copolymerization of the mixture of components a21, a22 and, if appropriate, a23 in the presence of the graft base a1 is carried out in such a way as to give a degree of grafting in the graft copolymer A of from 10 to 70% by weight, preferably from 20 to 60% by weight, in particular from 30 to 55% by weight, based on the total weight of component A. Since the graft yield in the graft copolymerization is generally not 100%, the amount used of the monomer mixture composed of a21, a22 and, if appropriate, a23 in the graft copolymerization should be somewhat greater than that corresponding to the desired degree of grafting. The control of graft yield during the graft polymerization and therefore of the degree of grafting of the finished graft copolymer A is familiar to the person skilled in the art and can by way of example be achieved inter alia via the feed rate of the monomers or via addition of regulator. The determination of degree of grafting is described by way of example in US 2004/0006178 or EP 1 031 609.

Between the preparation of the graft base and the application of the graft, an agglomeration step can be carried out in order to set particle sizes and particle size distributions in a controlled manner. The processes for the partial or complete agglomeration of the graft base al are known to the person skilled in the art, and the agglomeration can be undertaken by methods known per se to the person skilled in the art. For example, physical agglomeration processes such as freeze agglomeration or pressure agglomeration processes can be used, but it is also possible to use chemical methods. On the latter are the addition of electrolytes or of inorganic or organic acids. Preference is given to agglomeration undertaken by means of an agglomeration polymer. Examples of these that may be mentioned are polyethylene oxide polymers, polyvinyl ethers or polyvinyl alcohol.

The average particle size d₅₀ of the graft copolymers A is usually from 50 to 1200 nm, preferably from 50 to 1000 nm and particularly preferably from 50 to 850 nm. These particle sizes can be achieved by using, as graft base a1, particle sizes of from 50 to 1000 nm, preferably from 50 to 700 rim and particularly preferably from 50 to 600 nm. The particle size distribution can be mono-, bi- or multimodal. According to one particularly preferred embodiment of the invention, the particle size distribution is monomodal. According to a further embodiment, the particle size distribution of component A is bimodal, the average particle size of from 60 to 90% by weight being from 50 to 200 nm and that of from 10 to 40% by weight being from 200 to 850 nm, based on the total weight of the graft copolymer A.

The average particle sizes and particle size distributions stated are the sizes determined from the cumulative weight distribution. These and the further particle sizes stated for the purposes of the present invention are in all cases the weight-average particle sizes as determined by means of an analytical ultracentrifuge using the method of W. Scholtan and H. Lange, Kólloid.-Z. and Z.-Polymere 250 (1972), pages 782-796.

The term graft copolymer here is intended to include a mixture of different graft rubbers. By way of example, therefore, the solution, suspension or emulsion of one or more further graft rubbers can be added to the aqueous reaction mixture of a graft rubber. The mixture of these graft rubbers can then be isolated. A graft rubber is particularly preferably isolated from its reaction mixture.

The inventive graft copolymers A can be further used in the form in which they are produced in the reaction mixture, for example as latex emulsion or latex dispersion. As an alternative which is preferred for most applications, however, they can also be worked up in a further step. Measures for the work-up arc known to the person skilled in the art. Among these are by way of example isolation of the graft copolymers A from the reaction mixture, for example via spray drying or shear or via precipitation with strong acids or by means of nucleating agents, e.g. composed of inorganic compounds such as magnesium sulfate and, if appropriate, drying of the isolated rubber.

The inventive graft copolymers are suitable for impact-modification of thermoplastics. Impact-modified thermoplastics and thermoplastic molding compositions can be prepared via mixing with thermoplastic polymers.

### Component B (Thermoplastic Copolymer)

Preferred component B is polystyrene, polystyrene-acrylonitrile, poly-α-methylstyrene-acrylonitrile or a mixture of these. Preference is given here to copolymers B whose molar masses M_{w} are from 60 000 to 300 000 g/mol, and the molar masses can be determined via light scattering in dimethylformamide. In one preferred embodiment of the invention, component B is isolated after preparation by processes known to the person skilled in the art and preferably processed to give pellets.

### Component C

The further thermoplastic polymers C used can in particular comprise semicrystalline polyamides, semiaromatic copolyamides, polyesters, polyoxyalkylene, polyarylene sulfides, polyether ketone, polyvinyl chlorides and/or polycarbonates, preferably bisphenol-A-based polycarbonates. Preferred further polymer C is polyamide. However, it is also possible to use a mixture composed of two or more of the polymers C mentioned. The inventive thermoplastic molding compositions can comprise, based on components A plus B, from 0 to 90% by weight, preferably from 0 to 50% by weight, preferably from 0 to 20% by weight, of the polymer C.

### Component D

The inventive thermoplastic molding compositions can comprise, as component D, from 0 to 50% by weight, preferably from 0 to 40% by weight, in particular from 0 to 30% by weight, of fibrous or particulate fillers or of a mixture of these, always based on the amount of components A plus B.

By way of example, the fillers or reinforcing materials added can comprise glass fibers, which may have been equipped with a size and with a coupling agent; glass beads, mineral fibers, aluminum oxide fibers, mica, powdered quartz or wollastonite.

Other materials that can be admixed with the inventive molding compositions are metal flakes, metal powders, metal fibers, metal-coated fillers, such as nickel-coated glass fibers, and also other additions which screen electromagnetic waves. It is also possible to add carbon fibers, carbon black, in particular conductive carbon black, or nickel-coated carbon fibers.

### Component E

Amounts of from 0 to 50% by weight, preferably from 0 to 40% by weight, of auxiliaries and processing additives E can be added to the inventive molding compositions. Conventional additives E that can be used are any of such substances which are usually used for the processing or modification of the polymers. Mention may be made of the following examples: dyes, pigments, colorants, antistatic agents, antioxidants, stabilizers for improving thermal stability, stabilizers for increasing lightfastness, stabilizers for raising hydrolysis resistance and for raising chemical resistance, agents to counteract decomposition by heat and in particular lubricants, these being advantageous for the production of moldings. These further additives can be fed at any stage of the preparation or production process, but preferably at an early juncture, in order that the stabilizing effects (or other specific effects) of the additive are utilized at an early juncture.

### Molding Compositions

The inventive molding compositions can be prepared from components A, B and, if desired, the further polymer C, fibrous or particulate fillers D and also conventional additives and processing aids E in any desired manner by any of the known methods. However, it is preferable that the components are blended via mixing in the melt, for example extruding, kneading or rolling the components together. This is carried out at temperatures in the range from 160 to 400° C., preferably from 180 to 280° C. In one preferred embodiment, the components are isolated to some extent or completely in advance from the solutions or, respectively, aqueous dispersions/emulsions obtained during the respective steps of preparation. By way of example, the graft copolymers A can take the form of moist or dry crumb/powder when mixed with pellets of the thermoplastic copolymer B.

The invention also provides the use of the molding compositions described for the production of moldings for example of sheets or semifinished products, of foils, of fibers or else of foams, and also provides the corresponding sheets, semifinished products, foils, fibers or foams. Processing can be carried out by means of the known methods of thermoplastics processing and in particular processing can be carried out via thermoforming, extrusion, injection molding, calendaring, blow molding, compression molding, pressure sintering or other types of sintering, preferably via injection molding.

Replacement of a portion of the acrylic monomers during construction of the graft base via olefins obtainable at low cost achieves a marked cost advantage.

Surprisingly, the inventive molding compositions were found to have increased chemical resistance when compared with the ABS polymers used hitherto.

Surprisingly, furthermore, the inventive molding compositions were found to have improved low-temperature toughness, and by way of example when 1-octene is component a2 the glass transition temperature T_{G} of the graft base is unexpectedly lower, at from −50 to −52° C., than T_{G} of straight poly-n-butyl acrylate polymers (T_{G}=from −44 to −46° C.) and poly-1-octene (T_{G}: −44° C.).

Surprisingly, furthermore, the inventive thermoplastics have paler intrinsic color, and this has marked advantages for further use since, for example, less colorant has to be used for coloring.

Introduction of the olefins into the graft base does not cause any disadvantageous change in the mechanical properties and weathering resistance of the thermoplastic molding compositions.

1-13. (canceled)

14. A thermoplastic molding compositions, comprising a graft copolymer A and a thermoplastic copolymer B in the following proportions by weight:
A. from 10 to 80% by weight of the graft copolymer A composed of
a1: from 30 to 90% by weight, based on the graft copolymer A, of a graft base a1 obtainable via the reaction of
a11: from 50 to 98.99% by weight, based on the graft base a1, of a C1-C10-alkyl ester of acrylic acid,
a12: from 1 to 49.99% by weight, based on the graft base a1, of a copolymerizable linear, branched or cyclic olefin having from 3, 4 or 5 to 12 carbon atoms, and
a13: from 0.01 to 10% by weight, based on the graft base a1, of a copolymerizable polyfunctional, crosslinking compound, where the entirety composed of graft based a1 and graft a2 gives 100% by weight; and
B. from 20 to 90% by weight of a thermoplastic copolymer B, where the entirety composed of graft copolymer A and of thermoplastic copolymer B gives 100%.

15. The thermoplastic molding composition according to claim 14, where a copolymerizable linear, branched or cyclic α-olefin having 3, 4 or from 5 to 12 carbon atoms is used as component a12 of the graft base.

16. The thermoplastic molding composition according to claim 14, wherein the graft a2 is prepared in the presence of the graft base a1 via reaction of
a21: from 60 to 95% by weight, based on the graft a2, of styrene and/or α-methylstyrene,
a22: from 5 to 40% by weight, based on the graft a2, of acrylnitrile,
a23: from 0 to 35% by weight, based on the graft a2, of further unsaturated monomers,
where the entirety of a21+a22+a23 gives 100% by weight.

17. The thermoplastic molding composition according to claim 14, comprising the further components C, D and E in the following proportions by weight, based on the entirety of components A and B, where A+B=100% by weight:
C: from 0 to 90% by weight of a further thermoplastic compound,
D: from 0 to 50% by weight of one or more fibrous or particulate fillers or a mixture thereof and
E: from 0 to 30% by weight of conventional additives and processing aids.

18. The thermoplastic molding composition according to claim 14, wherein the thermoplastic copolymer B is poly(styrene-acrylnitrile).

19. The thermoplastic molding composition according to claim 14, wherein component a11 is n-butyl acrylate.

20. The thermoplastic molding composition according to claim 14, wherein component a12 is propylene.

21. The thermoplastic molding composition according to claim 14, wherein component a12 is 1 butene or isobutene.

22. The thermoplastic molding composition according to claim 14, wherein the graft copolymer A is prepared via emulsion polymerization.

23. The method of using the copolymer obtained from the reaction of
a11: from 50 to 98.99% by weight of a C₁-C₁₀-alkyl ester of acrylic acid,
a12: from 1 to 49.99% by weight of a copolymerizable linear, branched or cyclic olefin having 3, 4 or 5 to 12 carbon atoms, and
a13: from 0.01 to 10% by weight of a copolymerizable polyfunctional, crosslinking compound,
where the entirety composed of a11+a12+a13 gives 100% by weight;
as graft base a1 for a graft copolymer A for the impact-modification of thermoplastics for the preparation of molding compositions according to claim 14.

24. The method of using a copolymer according to claim 23, where a copolymerizable linear, branched or cyclic α-olefin having 3, 4 or from 5 to 12 carbon atoms is used as component a12.

25. The method of using of molding compositions according to claim 14 for production of moldings, of semifinished products, of fibers, of foils, or of foams.

26. A molding, a semifinished product, a fiber, a foil or a foam comprising molding compositions according to claim 14.

27. The thermoplastic molding composition according to claim 15, wherein the graft a2 is prepared in the presence of the graft base a1 via reaction of
a21: from 60 to 95% by weight, based on the graft a2, of styrene and/or α-methylstyrene,
a22: from 5 to 40% by weight, based on the graft a2, of acrylnitrile,
a23: from 0 to 35% by weight, based on the graft a2, of further unsaturated monomers,
where the entirety of a21+a22+a23 gives 100% by weight.

28. The thermoplastic molding composition according to claim 15, comprising the further components C, D and E in the following proportions by weight, based on the entirety of components A and B, where A+B=100% by weight:
C: from 0 to 90% by weight of a further thermoplastic compound,
D: from 0 to 50% by weight of one or more fibrous or particulate fillers or a mixture thereof and
E: from 0 to 30% by weight of conventional additives and processing aids.

29. The thermoplastic molding composition according to claim 16, comprising the further components C, D and E in the following proportions by weight, based on the entirety of components A and B, where A+B=100% by weight:
C: from 0 to 90% by weight of a further thermoplastic compound,
D: from 0 to 50% by weight of one or more fibrous or particulate fillers or a mixture thereof and
E: from 0 to 30% by weight of conventional additives and processing aids.

30. The thermoplastic molding composition according to claim 15, wherein the thermoplastic copolymer B is poly(styrene-acrylnitrile).

31. The thermoplastic molding composition according to claim 16, wherein the thermoplastic copolymer B is poly(styrene-acrylnitrile).

32. The thermoplastic molding composition according to claim 17, wherein the thermoplastic copolymer B is poly(styrene-acrylnitrile).

33. The thermoplastic molding composition according to claim 15, wherein component a11 is n-butyl acrylate.
